(19) United States
(12) Patent Application Publication
(10) Pub. No.: US 2016/0376812 A1
(43) Pub. Date: Dec. 29, 2016

(54) ADJUSTABLE ELECTROMECHANICAL LOCK

(71) Applicant: DESI Alarm ve Guvenlik Sistemleri San. ve Tic. A.S, Istanbul (TR)

(72) Inventors: Tuncay Erhan YANAR, Istanbul (TR); Ömer DOGAN, Istanbul (TR)

(73) Assignee: DESI Alarm ve Guvenlik Sistemleri San. ve Tic. A.S ., Istanbul (TR)

(21) Appl. No.: 15/190,195

(22) Filed: Jun. 23, 2016

(30) Foreign Application Priority Data
Jun. 23, 2015 (EP) 15173366.4

(51) Int. Cl. E05B 9/04; E05B 47/00; E05B 1/00; G07C 9/00

(52) U.S. Cl. CPC E05B 9/045; G07C 9/00563; E05B 47/0012; E05B 1/0007; E05B 2047/0058; E05B 2047/0084; E05B 2047/0094; E05B 2009/046

(57) ABSTRACT

An electromechanical lock comprises a rotary knob, a motor built-in for locking and unlocking by way of rotation of a main shaft, a remote control unit for authenticating authorized users prior to granting permission and communicating such information to a driver circuitry which is in communication with said motor, said electromechanical lock further comprising a lock cylinder adjoined to rotary knob through an adaptor portion, having a first and second half-housings divided by a notch in which a rotatably arranged pawl is driven. Said electromechanical lock further comprises a locking pin slot, arranged on the lock cylinder, into which a locking pin can be driven; an adjustment member slot intersecting with the locking pin slot; said adjustment member slot arranged on the lock cylinder, into which an adjustment member can be inserted for blocking movement of the locking pin such that longitudinal length of the rotary knob is arranged.

### TECHNICAL FIELD OF THE INVENTION

The present invention relates to an electromechanical lock, more particularly to an electromechanical lock suitable for instantly substituting an existing lock mechanism by way of easy mounting, and to be extended or shortened at any time when an arrangement is required.

### BACKGROUND OF THE INVENTION

Electromechanical lock mechanisms or electrical locks are widely used overall the world and are especially convenient for multiple access control systems. Although requiring an electrical power source and wiring, electromechanical locks for individual home users are also available in the market. Such locks can be modified to be incorporating a power source without requiring further wiring for home users. Those are however still deficient in that it is not always possible to replace an existing conventional cylinder lock mechanism with an electromechanical lock by way of easy and instant mounting properly.

Electrical or electromechanical locks of the type enabling control of authorized users are also practiced in prior art systems and are commercially available. The EP publication EP1418295 (A1), among many others, represents an electromechanical lock pertinent to the subject-matter of the preamble of Claim 1 of the present invention. It discloses an electromechanical lock combined with rotary knob having operating means, which have a profile with an outer contour of a standard lock cylinder. This type of electromechanical locks having micro-mechanical systems employs advanced technology so that sometimes technical problems may occur and require technical service and maintenances. In such a case, if the service personnel identify a problem that cannot be solved on-site, the electromechanical lock is fully uninstalled from the door, which may cause security problems.

Furthermore said conventional lock cylinders already mounted the doors may have different size and shapes. One of the common drawbacks of this type electromechanical locks are that the lock cylinder may have a different size and shape which causes the problem in replacing of said electromechanical lock with said lock cylinder. Another drawback is that the electromechanical locks come with cylinder lock built-in which prevents any length arrangement when it is required.

The electromechanical locks existing in the state of the art are mounted to the cylinder part which is attached specifically with a motor and a control unit during the production, by means of a plurality of screws. However, these types of electromechanical locks do not allow the motor and the control unit to be disassembled from the lock cylinder when needed during mounting to the door or making a certain amount of adjustment for the various door thicknesses. To this end, sometimes mismatch and maladjustment may be experienced while fitting the cylinder lock to the intended place in the door lock or the like. In this case, it becomes important to assemble the cylinder to the intended place as an ordinary mechanical lock cylinder by disassembling thereof from the other system. Furthermore, said cylinder locks can be mounted to the door only by producing special cylinders for the door provided that the door thickness is greater than a certain amount. Even a height problem of 1-2 mm prevents electromechanical locks to be mounted to the door.

Therefore an electromechanical lock which is easily adaptable to replace an existing conventional lock mechanism and arrangement about its position is of need in the market. In addition to this, said electric lock having motor are in the form of built-in with conventional locks such that if the replacement area has a different size than replacement of the electric lock may not fit in the area.

### OBJECTS OF THE INVENTION

The primary object of the present invention is to provide an electromechanical lock having a rotary knob whose length can be easily and accurately adjusted as desired such that the problems experienced during mounting is minimized.

Another object of the present invention is to provide an electromechanical lock that can be mounted as fast as possible to the extent that it practically requires the same amount of work and time compared to replacing said existing conventional cylinder mechanism with another conventional cylinder mechanism.

Another object of the present invention is to provide an electromechanical lock which allows the motor and the electromechanical module to be disassembled when in need by means of an adjustment member.

Another object of the present invention is to solve the majority of the problems caused by the mismatch or short height due to the diverse door thicknesses.

In particular, the object is to provide an electromechanical lock which allows using the existing cylinder lock manually during repair and maintenance processes by disassembling only the motor and the relevant electromechanical module of the electromechanical lock from the cylinder during the repair process.

Another object of the present invention is to provide an electromechanical lock whose rotary knob can be attached to any type of lock cylinder which having suitable slots for adjustment means.

Another object of the present invention is to provide an electromechanical lock with which it is possible to produce cylinder locks of different lengths from the same individual parts. As a result, it is possible to achieve considerable rationalization and a considerable reduction in terms of storage.

### SUMMARY OF THE INVENTION

An electromechanical lock comprises a rotary knob, a motor built-in in the rotary knob for locking and unlocking by way of rotation of a main shaft, preferably as remote control unit for authenticating authorized users prior to granting permission and communicating such information to a driver circuitry which is in communication with said motor, said electromechanical lock further comprising a lock cylinder adjoined to rotary knob through an adaptor portion, having a first and second half-housings divided by a notch in which a rotatably arranged pawl is driven. Said electromechanical lock further comprises a locking pin slot, arranged on the lock cylinder, into which a locking pin can be driven; an adjustment member slot intersecting with the locking pin slot; said adjustment member slot arranged on the lock cylinder, into which an adjustment member can be inserted for blocking movement of the locking pin such that longitudinal length of the rotary knob is arranged.

### BRIEF DESCRIPTION OF THE FIGURES

Accompanying drawings are given solely for the purpose of exemplifying an electromechanical lock whose advantages over prior an were outlined above and will be explained in detail hereinafter:

FIG. 1 demonstrates a perspective view of an electromechanical lock where a lock cylinder and rotary knob are detached according to the prior art.

FIG. 2 demonstrates a perspective view of an electromechanical lock according to the present invention.

FIG. 3 demonstrates a perspective view of a lock cylinder of an electromechanical lock according to the present invention.

FIG. 4a demonstrates a cross-sectional view of lock cylinder and a perspective view of a rotary knob according to the present invention

FIG. 4b demonstrates a cross-sectional view of a lock cylinder and perspective view of a rotary knob according to the present invention where an adjustment means are detached according to the present invention.

FIG. 5 demonstrates an exploded view of an electromechanical lock according to the present invention

FIG. 6 demonstrates a perspective view of a rotary knob and a partial cross-sectional view of a lock cylinder according to the present invention.

FIG. 7 demonstrates a perspective view of an electromechanical lock mounted to a door according to the present invention.

FIG. 8a demonstrates a perspective view of an adaptor portion with a main shaft according to the present invention.

FIG. 8b demonstrates another perspective view of an adaptor portion with a main shaft according to the present invention.

FIG. 9 demonstrates a perspective view of a remote control unit in wireless communication with driver circuitry according to the present invention.

FIG. 10 demonstrates a disassembled view of another embodiment of an electromechanical lock according to the present invention.

FIG. 11 demonstrates a perspective view of the electromechanical lock showing how an adjusting tool may be inserted into one end of the slot in order to turn the adjustment member shown in FIG. 10.

### DETAILED DESCRIPTION OF THE INVENTION

10. Electromechanical lock
11. Rotary knob
12. Lock cylinder
13. Adjustment member
13a. Lower portion
13b. Intermediate portion
13c. Threaded portion
14. Locking pin
15. Flat portion
16. Adjustment member slot
16a. Adjustment member hole
17. Locking pin slot
17a. Locking pin hole
18. Hole
19. Pawl
20. Notch
22. Knob cover
23. Battery
24. Motor
25. Main shaft
26. Drive circuitry
27. Adaptor portion
28. Gear mechanism
29. Rotary member
30 Door
32. Connection member
33. Adjustment portion
36. Battery block
37. Connecting rod
39. Conductive member
40. Outer portion
41. Tip
47. Slit
49. Remote control unit
50. First half housing
51. Second half housing
52. Connection hole
53 Locking pin
56 Adjustment member slot
57 Locking pin slot
58 Adjustment member
59 Threaded portion
Z Inclined axis
X Longitudinal axis
Y Vertical axis

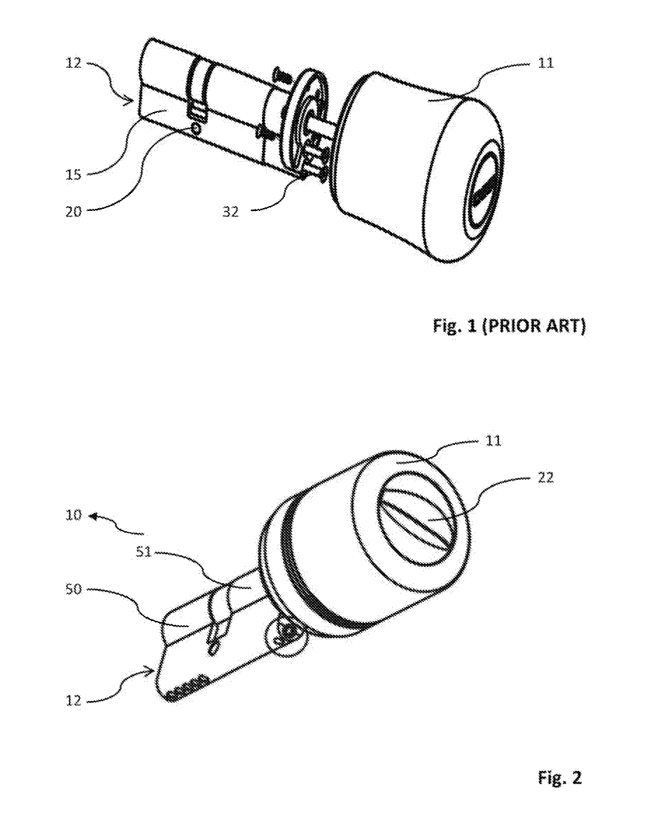

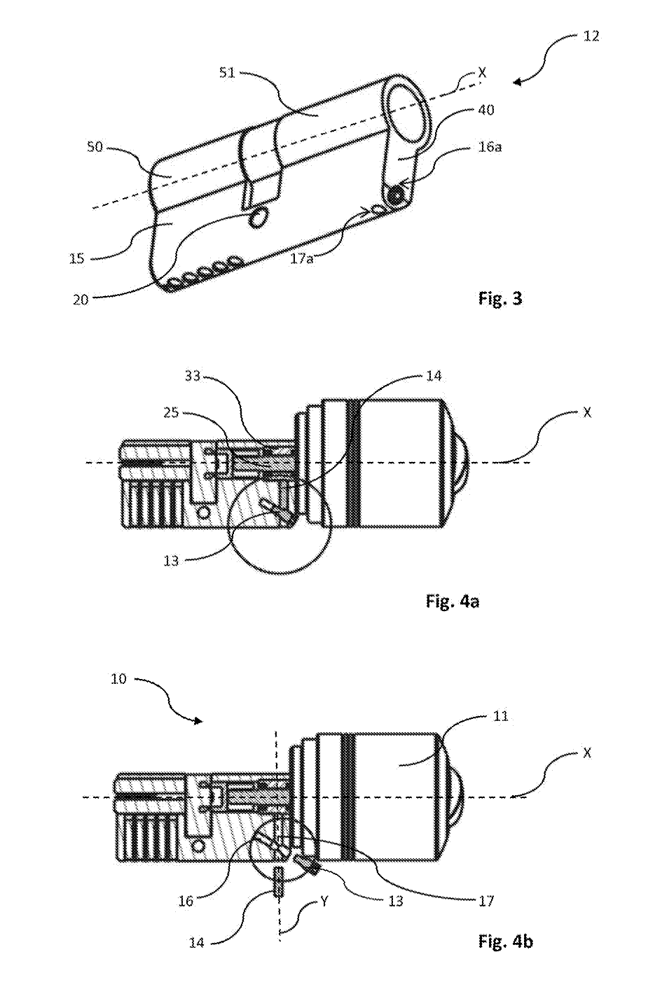

Referring now to the figures outlined above, an electromechanical lock (10) essentially comprises a conventional type lock cylinder (12) and a rotary knob (11) for operating said lock cylinder (12). Said electromechanical lock (10) according to the present invention, also can be referred as a lock mechanism, electrical lock, electrical lock mechanism, is designed to be mounted on almost every door previously comprising a conventional cylinder lock mechanism. The electromechanical lock (10) according to the present invention can easily and instantly be mounted to replace an existing conventional lock cylinder. Accordingly, steps taken in order for mounting the electromechanical lock assembly of the present invention are similar to those for mounting a conventional cylinder lock without requiring any further step. In the prior art, as can be seen in FIG. 1, a plurality of connection members (32) are used for connection of a rotary knob without allowing any length adjustment when it is required.

The lock cylinder (12) of the electromechanical lock (10) comprises a pawl (19) arranged between two half-cylinders for operating cylinder locking mechanisms and a longitudinally extending cylindrical portion in the form of coaxially arranged a first and second half-housings (50, 51) and a flat portion (15) extending parallel to the upper cylindrical portion with a notch (20) in the middle, through which said pawl (19) is rotatably movable between said first and second half-housings (50, 51). Said lock cylinder (12) is equipped with a key slot for effecting unlocking by means of a key operable from the opposite side of said rotary knob (11). A user may unlock the mechanism from outside both through convention always, for example by using a proper key or through biometric or other authentication methods as a matter of choice will be mentioned later. If the rotary knob (11) is engaged with a rotary member (29) by the means of the main shaft, the rotary knob (11) and, with it, the pawl (19) can be rotated.

In a preferred embodiment, FIG. 6 shows how an adjustment member (13) may be easily tightened or loosened by means of an adjusting tool such as an Allen wrench. In this figure, the lock cylinder (12) is adjoined to rotary knob (11) through an adaptor portion (27), the latter being coupled to a driver circuitry (26) connecting said adaptor portion (27) to a battery bloc (36) and to a motor (24) which conventionally drives a gear mechanism (28) through its shaft. A gear mechanism (28) having at least one gear, is placed between the driver circuitry (26) and the adaptor portion (27). Said battery bloc (36) communicates with said motor (24) through a conductive member (39). An adjustment portion (33) through which a main shaft (25) extends, is designed to integrate the adaptor portion (27). Said adjustment portion (27) has a plurality of hole (18) sized and shaped according to a locking pin (14) for the adjustment of longitudinal length of the main shaft (25).

The motor (24) is typically a small brushed or brushless DC motor in which speed and torque control can easily be done by adjusting the voltage and high operating torque with a reduced speed can be achieved in order for unlocking the door.

Again referring to FIG. 6, said main shaft (25) has a fiat tip (41) for fitting to the rotary member (29) which is in communication with the pawl (19). On the other hand, said rotary member (29) has a slit (47) sized and shaped according to the flat tip (41) of the main shaft (25). Said main shaft extends along the adaptor portion (27), the drive circuitry (26) and the adjustment portion (33), and couples with the pawl (19) by the means of the rotary member (29) which is placed inside of the second half housing (51).

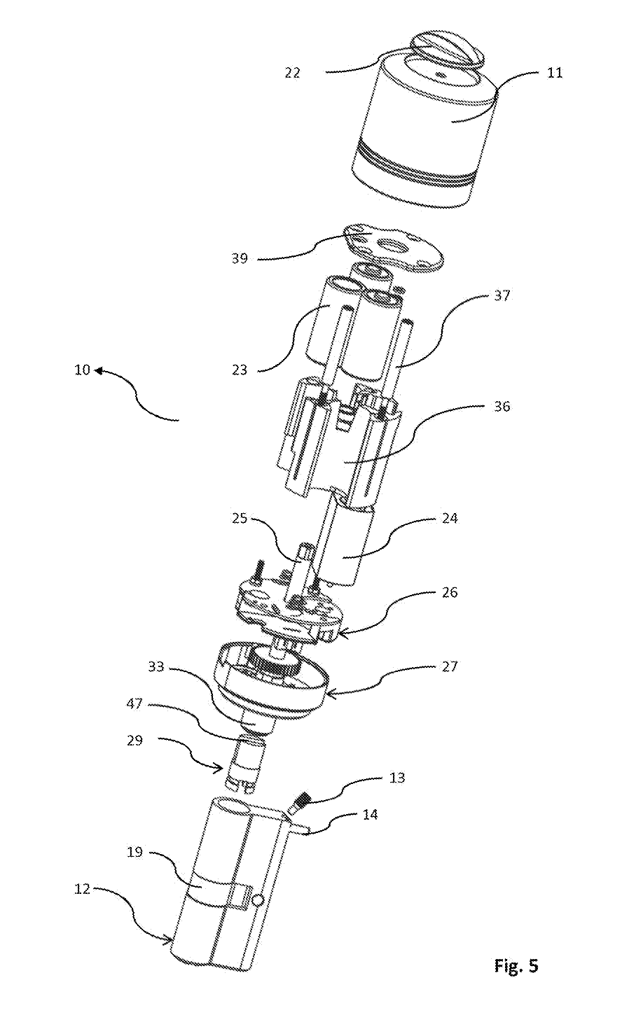

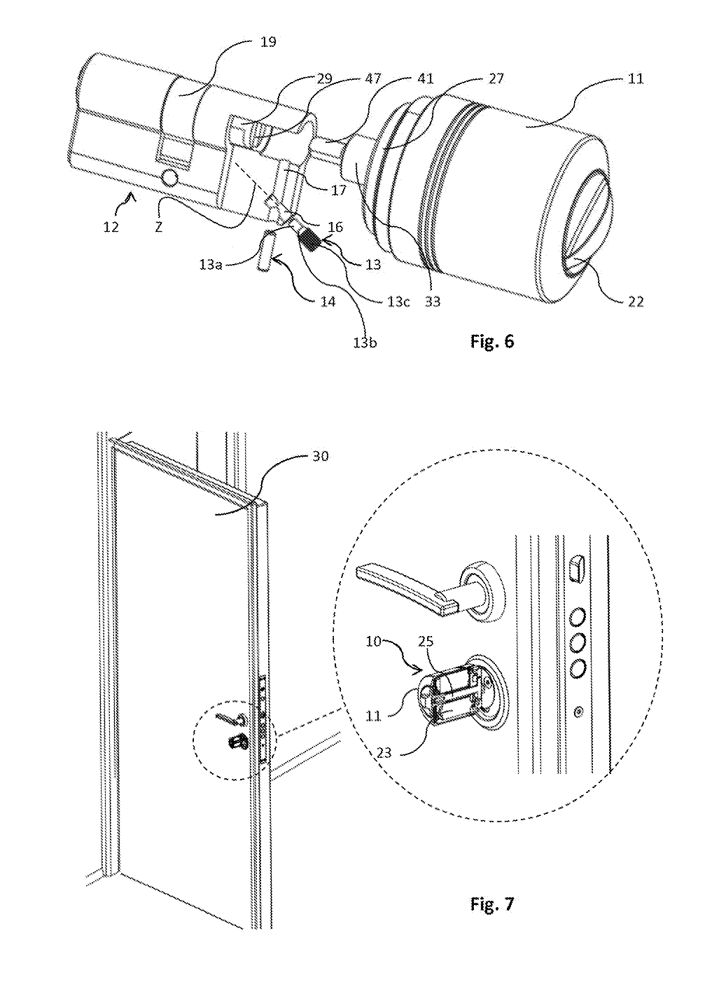

Referring to FIG. 5, at least one battery (23), preferably three, e.g. AA size alkaline batteries, used to power the motor, are placed on the battery bloc (36) having suitable housing for said at least one battery (23) in a circular way. At least one connection rod (37), preferably three, goes through all the way through suitable channel of the battery bloc (36) and connects to at least one connection hole (52) of the adaptor portion (27).

As an essential approach adopted by the preferred embodiment of the present invention offers an easy replacement of electromechanical lock (10) and enabling a transversely length adjustment of rotary knob (11) when it is required during the mounting of the electromechanical lock to the door or the like. In addition to this, the preferred embodiment of the present invention also allows detachment of the rotary knob (11), i.e. when any malfunction arises on it.

Said electromechanical lock (10) can be adjusted by way of turning the adjustment member (13) which is inserted from an adjustment member hole (16a) located at the lower part of an outer portion (40) of the lock cylinder (12). Said adjustment member hole (16a) is also formed naturally to allow an Allen key to access to the adjustment member (13).

Similarly, a locking pin (14) in a form of cylindrical hollow shape is inserted from a locking pin hole (17a) to a locking pin slot (17) which is preferably located at lowermost of the lock cylinder (12). Said adjustment member slot (16) and locking pin slot (17) intersect with each other, therefore, said adjustment member (13) and locking pin (14) are also interact with each other when guided in their slots.

In the preferred embodiment, as it can be seen in FIG. 4a, said adjustment member (13) advances on an inclined axis (Z) with respect to a longitudinal axis (X) of the lock cylinder (12). On the other hand, said locking pin (14) advances on a vertical axis (Y) with respect to the longitudinal axis (X) of the electromechanical lock (10). If the electromechanical lock (10) does not fit to the intended place during mounting, the rotary knob (11) can be disassembled by loosening the adjustment member (13). As can be seen in FIG. 4a, the adjustment member (13) is rotated for a movement of the locking pin (14) on a vertical direction according to the longitudinal direction of the electromechanical lock (A) that causes to engagement of the locking pin with one of holes (18) located on the adjustment portion (33) of an adaptor portion (27) such that a main shaft of the rotary knob (11) can be hold firmly in a desired position. The adjustment portion (33) of an adaptor portion (27) is guided in the second half-housing (51) through which the main shaft (25) extends, during mounting, when an desired position of the rotary knob (11) is readied, said adjustment member is rotated on the, preferably, clockwise direction that causes rising of the locking pin (14) in its slot for fitting one of the holes of the adjustment portion (33). Said adjustment member (13) is a preferably screw, more preferably, an allen screw adjustable by turning in its slot with an suitable allen key. Said adjustment member (13) is being free to turn by means of the allen key through in its slot (16). When the adjustment member (13) is turned by means of an Allen key, the locking pin (14) is pushed by the adjustment member (13) through the locking pin slot (17). As the consequence, the locking pin (14) moves in its slot in the vertical axis (Y) with respect to longitudinal axis (X) of the electromechanical lock (10), and engages with one of the holes (18) of the adaptor portion (27) such that especially longitudinal length of the electromechanical lock is arranged.

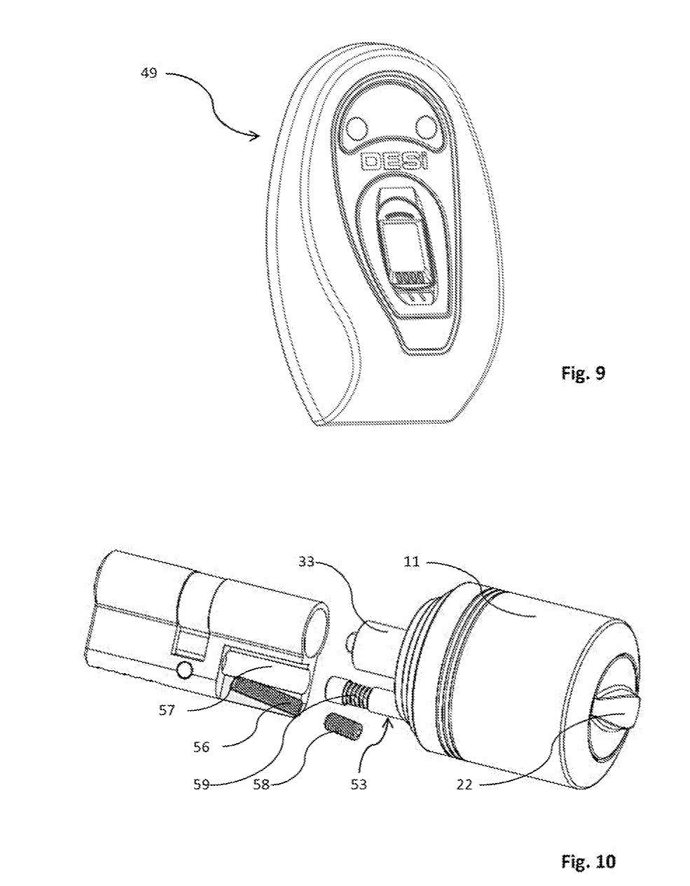

Referring to FIG. 5, the motor (24) encapsulated by rotary knob (11) is driven to operate and unlock the lock only when a user is granted authorization, i.e. in the case of a biometric lock only when a pre-registered fingerprint pattern is authenticated by a remote control unit (49) and information of authorization status is communicated to the drive circuitry (26). As shown in FIG. 9, the remote control unit (49) can be a fingerprint reader module, communicating with the rotary knob (11) according to the present invention may be of any suitable type as long as it is convenient for achieving the general object of the invention, i.e. providing fingerprint authentication and establishing wireless communication with the drive mechanism. In addition, when a user rotates said rotary knob (11) mechanically, i.e. by using knob cover (22), the motor's (24) shaft being also rotated due to the configuration of the gear mechanism (28), the latter will sense the direction of the rotation due to the induced voltage and rotates the main shaft (25) itself after the user started rotation. The motor (24) is therefore responsive to the rotation of the main shaft (25) such that it is activated thereupon.

If thickness of a door or the like is greater than expected during mounting the rotary knob (11) to the intended place, the main shaft (25) of the rotary knob (11) inside the lock cylinder (12) can be shortened or prolonged again by loosening or tightening the adjustment member (13). Referring to FIG. 5, firstly, the locking pin (14) is placed its slot (17) and then said adjustment member (13) is inserted from the adjustment member hole (16a) to its slot (16). By way of turning the adjustment member (13) press the locking pin (14) which in result rotary knob (11) to be hold firmly. Rotating of the adjustment member (13) allows making an adjustment, preferably, up to 6 mm at 2 mm intervals in the standard production and up to a certain length predetermined by the customer in the specific and customer-oriented locks.

The adjustment member (13) is retained in a manner such that it can rotate relative to the lock cylinder (12). The locking pin (14) and adjustment member (13) guide through their slots (17, 16), respectively, such that movement of locking pin (14) adjusts the position of the rotary knob (11) relative to the lock cylinder (12). Rotation of the adjustment member (13) causes a moving force on the locking pin (14) along a vertical direction according to the longitudinal axis (A) of the electromechanical lock (10). As can be seen in FIG. 4a, the adjustment member slot (16) is provided at an angle relative to the locking pin slot (17) such that a user can accurately set the shaft (25) of the rotary knob (11). Once the adjustment member (13) has been adjusted, by rotating clockwise in its slot, also accidental or unintentional movement of the said locking pin is prevented and kept firmly in its slot just after desired position of the rotary knob is adjusted.

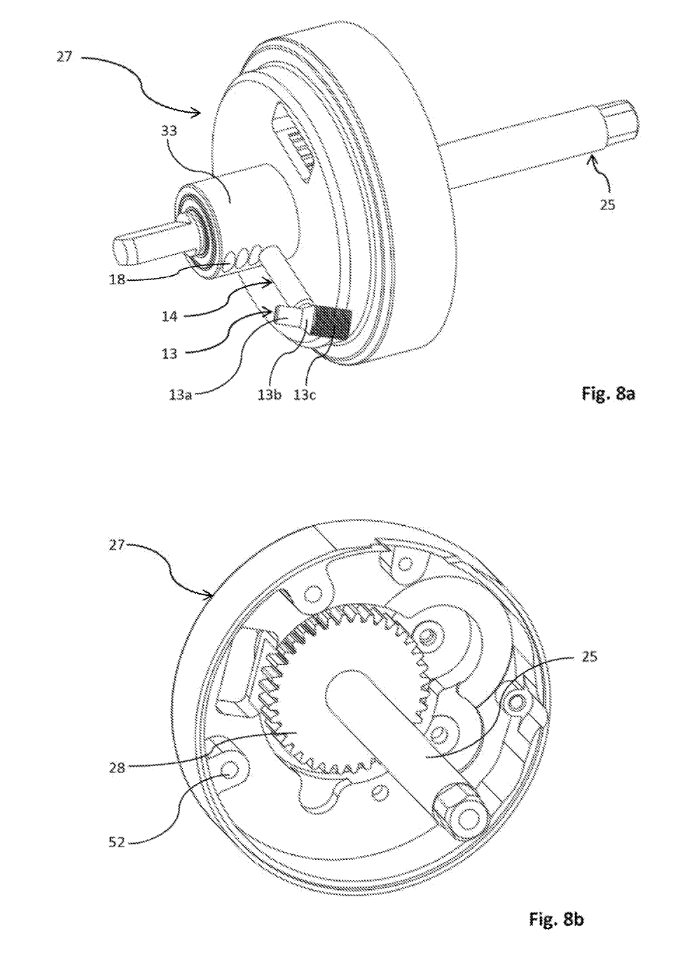

Said adjustment member (13) can be a screw, bolt or allen screw, preferably stay bolt or headless setscrew having a flat tip portion reduced in diameter. In addition, said adjustment member (13), preferably partially threaded, has no head projecting, passes through a substantially hollow threaded slot and mostly driven with an internal-wrenching drive, such as a hex socket (Allen), star (Torx), square socket (Robertson). Said adjustment member (13) has a screw thread portion (13c) formed in the uppermost part. An intermediate portion (13b) of the adjustment member (13) is formed substantially conically shaped as shown in FIG. 8a. Furthermore, a lower portion (13a) is a flat tip protruding from one end of the adjustment member (13) reduced in diameter of the adjustment member (13), slightly below the root diameter of the thread portion (13c), goes first its slot, and is substantially in cylindrical shape. The lower portion (13a) of the adjustment member (13) is firstly inserted from adjustment member hole (16a) and, then, driven with a suitable tool that causes the conically shaped intermediate portion (13b) push the locking pin (13) along the way of the locking pin slot (17) and an engagement of the locking pin (13) with one of holes (18) provided on the adjustment portion (33) of the adapter portion (27).

Although not being a distinguishing feature, the remote control unit (49) and the rotary knob (11) unit according to the present invention communicate with each other using RF to grant permission for uniquely identified fingerprint patterns. The two-way encoded communication and hardware enabling such communication is not of interest as far as the present invention is concerned.

Any cylinder lock producer may also arrange said adjustment member slot (16) and locking pin slot (17) on their lock cylinders so that the rotary knob (11) can be easily attached to the cylinder lock by means of the locking pin (14) and adjustment member (13). It will be appreciated that the position of the adjustment member slot (16) and the locking pin slot (17) may vary. Furthermore it will be appreciated that the specific embodiment described herein includes features not essential to the invention, the scape of which is defined by the claims.

Said adaptor portion is arranged to be slidable in the second half housing (51) and connect with rotary member by its tip portion. The longitudinal length of the main shaft (25) can be extended or shortened by sliding the adjustment portion (33) in the second half housing (51). If the adjustment portion (33) is withdrawn a little bit, the rotary knob (11) is correspondingly extended. For this purpose, the adjustment portion (33) and of at least two holes are provided. In order to fix the desired position of the rotary knob, adjustment portion has a plurality of holes, into which the locking pin (14) can be inserted.

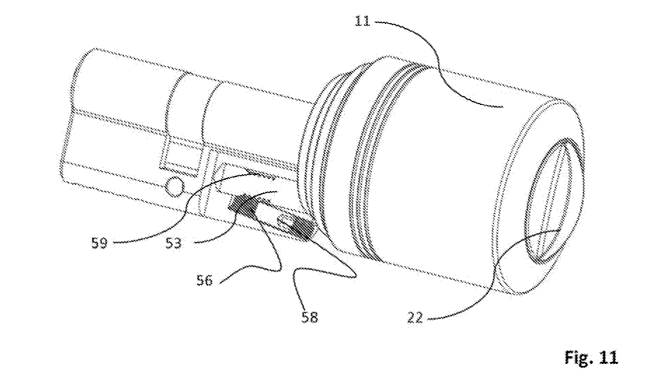

Referring to the FIGS. 10 and 11, another embodiment of the electromechanical lock (10) is shown. In this embodiment, an adjustment member slot (56) can be formed substantially fully threaded in which an adjustment member (58) having corresponding threads is guided. The adjustment member slot (16, 56) intersects with the locking pin slot (17, 57). Said adjustment member (58) has a hole facing, outside, through which an allen key can access to the drive of the adjustment member (58). As can be seen in FIG. 10, contrary to the preferred embodiment of the present invention, another locking pin slot (57) can be arranged on the longitudinal axis (X) of the lock cylinder (12). A locking pin (53) can be attached the adaptor portion (27) and then guided in the locking pin slot (57). Said locking pin (53) has at least partially threaded portion (59) which can be blocked by the rotation of the adjustment member (58). The adjustment member (58) is free for turning. When the adjustment member (58) is turned by means of an Allen key, one end of the adjustment member (58) touches to the threaded portion (59) of the locking pin (53) and prevents its movement in its slot (57).

Overall length of the electromechanical lock (10) can be established by first adjusting the desired length of the rotary knob (11) and then tightening the adjustment member (13, 58) by the allen tool until the desired tightness is obtained. As such, the distance between the adjustment member slot (16) and locking pin slot (17) may be varied as necessary. The adjustment member (58) threaded in its slot engages the threaded portion (59) of the locking pin (53) preventing the locking pin (53) sliding out of the locking pin slot (57).

Different aspects of the present invention have been described by way of example only and it should be appreciated that modifications and additions may be made thereto without departing from the scope thereof.

1. An electromechanical lock (10) comprising a rotary knob (11), a motor (24) built-in in the rotary knob (11) for locking and unlocking by way of rotation of a main shaft (25); said electromechanical lock (10) further comprising a. lock cylinder (12) adjoined to rotary knob (11) through an adaptor portion (27), having a first, and second half-housings (50, 51) divided by a notch in which a rotatably arranged pawl (19) is driven,
characterized in that the electromechanical lock (10) further comprises:
a locking pin slot (17, 57) arranged on the lock cylinder (12), into which a locking pin (14, 53) can be driven;
an adjustment member slot (16, 56) intersecting with the locking pin slot (17, 57); said adjustment member slot (16, 56) is arranged on the lock cylinder (12), into which an adjustment member (13, 58) can be inserted for blocking movement of the locking pin (14, 53) such that longitudinal length of the rotary knob (11) is arranged; and
wherein said locking pin (13) is movable on a vertical axis (Y) with respect to a longitudinal axis (A) of the electromechanical lock (10) for an engagement with at least one hole (18) of an adjustment portion (33) integrated with the adaptor portion (27).

2. An electromechanical lock (10) as set forth in claim 1 wherein said locking pin (14) is in a form of cylindrical hollow shape for easily slidable in the locking pin slot (17).

3. An electromechanical lock (10) as set forth in claim 1 wherein said adjustment member (13) has at least partially threaded portion (13c) formed in the uppermost part.

4. An electromechanical lock (10) as set forth in claim 1 wherein the adjustment member (13) has an intermediate portion (13b) formed conically shaped which is in communication with locking pin (14) when an adjustment is done.

5. An electromechanical lock (10) as set forth in claim 1 wherein said motor (24) is responsive to the rotation of the main shaft (25) such that it is automatically actuable thereupon.

6. An electromechanical lock (10) as set forth in claim 1 wherein said lock cylinder (12) is equipped with a key slot for effecting unlocking by means of a key operable from an opposite side of said rotary knob (11).

7. An electromechanical lock (10) as set forth in claim 1 said motor (24) is in a communication with a remote control unit (49) for authenticating authorized users prior to granting permission.

8. An electromechanical lock (10) as set forth in claim 1 wherein said remote control unit (49) is a fingerprint reader module.

9. An electrical lock system as set forth in claim 7 wherein said remote control unit (49) is adapted to establish wireless communication with a driver circuitry (26).

10. An electromechanical lock (10) as set forth in claim 1 said rotary knob (11) is equipped with built-in at least one battery (23) for powering the electromechanical lock (10).

11. An electromechanical lock (10) as set forth in claim 1 said at least one hole (18) of an adjustment portion (33) is shaped and dimensioned according to the locking pin (14).

12. An electromechanical lock (10) as set forth in claim 1 said locking pin (53) is attached to the adaptor portion (27) for guiding in the locking pin slot (57).

13. An electromechanical lock (10) as set forth in claim 1 said locking pin (53) has at least partially threaded portion (59) which can be blocked by the adjustment member (58).
